(19) United States
(12) Patent Application Publication
(10) Pub. No.: US 2005/0268269 A1
(43) Pub. Date: Dec. 1, 2005

(54) Methods and systems for cross-probing in integrated circuit design

(75) Inventor: Mark Coiley, Campbell, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Tera Systems, Inc., San Jose, CA (US)

(21) Appl. No.: 11/141,394

(22) Filed: Jun. 1, 2005

Related U.S. Application Data
(60) Provisional application No. 60/575,385, filed on Jun. 1, 2004.

(51) Int. Cl. G06F 9/455; G06F 17/50

(52) U.S. Cl. 716/11; 716/4

(57) ABSTRACT

When designing integrated circuits, RTL source code is received and converted into objects. Objects may include a reference to relevant lines of source RTL code. A graphical user interface (“GUI”) displays the RTL code in an RTL window. The GUI also displays one or more representations of the objects in additional windows. The GUI uses references between the objects and the RTL code to map between the RTL code window and the window(s) of the one or more representations. When a user highlights a portion of one window, the corresponding portions of other windows are automatically highlighted by the GUI. A tool in accordance with the invention optionally operates in conjunction with one or more analysis tools that automatically highlight portions of one or more windows to illustrate potential errors or timing issues. Timing diagrams showing timing delays between various elements of a block may also be displayed.

### CROSS-REFERENCE TO RELATED APPLICATIONS

The present invention claims the benefit of U.S. Provisional Application No. 60/575,385, filed Jun. 1, 2004, which is hereby incorporated by reference herein in its entirety.

### SUMMARY OF THE INVENTION

In integrated circuit (“IC”) design, source code is received by an IC design tool. The IC design tool generates instances of objects representative of one or more features within the source code. The instances are used in one or more graphical representations of the source code. For example, and without limitation, the IC design tool generates a physical hierarchy, a synthesis hierarchy, a logical hierarchy, one or more timing schematics, one or more logic schematics, and/or combinations thereof.

Each object includes a reference to the section of source code that defines the instance. As a result, each object can be mapped back to its corresponding source code. The graphical representations of the objects also include a similar reference. Each representation or instance of a particular object can therefore be linked, or cross-referenced, to other representations or instances of the same object. In other words, an object instance that appears in a first graphical representation of the source code can be mapped back to the corresponding source code, and can then be mapped forward to instances in other graphical representations of the source code. This is referred to herein as cross-probing between representations and/or instances of the source code.

Cross-probing can be used in a variety of ways. For example, and without limitation, cross-probing optionally permits a user and/or a computer function to identify (e.g., highlight) an object instance, simultaneously in multiple graphical representations of the source code, along with the object's corresponding source code.

Cross-probing optionally permits a user and/or a computer function to manipulate an object simultaneously in multiple graphical representations of the source code, and in the source code itself. In other words, an action taken towards one graphical representation of an object is reflected in other graphical representations of the object and/or its corresponding source code.

The graphical representations of the source code are optionally displayed on a graphical user interface (“GUI”). The GUI can display several types of representations. For example, the GUI may display the original source code. The GUI may also display the representations in the format of hierarchies, which show the parent-child relationships between objects. The GUI may display the representations in the format of diagrams, such as layout diagrams and/or schematic diagrams. As another example, the GUI may display the representations in one or more timing reports.

Cross-probing between representations of a single object is optionally used in troubleshooting an IC design. For example, a representation of an object that does not meet timing criteria (i.e., an element in a critical path), may be highlighted in a timing diagram. A cross-probing tool then highlights the object as it occurs in other graphical representations of the source code. In addition, the corresponding lines of source code may be highlighted. This allows a user to examine and possibly revise the corresponding source code. The invention is not, however, limited to this example. Based on the teachings herein, one of skill in the relevant art(s) will recognize that cross-probing can be utilized for other purposes without departing from the spirit and scope of the present invention.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is an example process flowchart for processing RTL using objects.

FIG. 2 is another example process flowchart for processing RTL using objects.

FIG. 3 is a flowchart of an example method for cross-probing between multiple graphical representations of objects in an integrated circuit design.

FIG. 4 is a screenshot of an example graphical user interface according to an embodiment of the present invention.

FIG. 5 is another screenshot of an example graphical user interface according to an embodiment of the present invention.

The present invention will be described with reference to the accompanying drawings. The drawing in which an element first appears is typically indicated by the leftmost digit(s) in the corresponding reference number.

### DETAILED DESCRIPTION OF THE INVENTION

I. Integrated Circuit Design Overview
   A. Front End: RTL and Synthesis
   B. Back End: Place and Route
II. Advanced Optional Processing Features, Abstract Representations of RTL, and Physical Synthesis
   A. Standard Cell Objects
   B. Logic Objects
   C. Memory and IP Blocks
   D. Hierarchies
   E. Hard Objects, Pseudo Hard Objects and Soft Objects
III. Example Environment for RTL Processing with Abstract Objects
   A. Generation of Libraries of Logic Objects
   B. Physical Synthesis Using Libraries of Logic Objects
IV. Cross-probing
   A. Representations Linked to Source RTL
   B. Graphical User Interface
   C. Example Application

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

I. Integrated Circuit Design Overview

Integrated circuits are designed using computer-based hardware description languages (“HDLs”). Several types of HDL exist, including but not limited to verilog, VHDL, systemC, and System Verilog. HDLs can be used at a variety of design levels, including register transfer level (“RTL”), behavioral, and electronic system level (“ESL”). Although the present application will describe the invention with reference to RTL code, a person of ordinary skill in the art will recognize that any type of logic source code (e.g., any HDL), at any design level, may be used.

EDA tools are typically classified as front-end or back-end tools. Front-end EDA tools typically operate on HDL code and/or abstract representations of functions associated with the HDL code. Conventional front-end EDA tools attempt to optimize the HDL code and/or the abstract representations. For example, synthesis and technology mapping, functional verification, and/or initial timing analyses can be performed.

Conventional front-end EDA tools utilize rough estimates or statistical estimations of characteristics of the eventual integrated circuit design. The characteristics can include timing and/or power consumption. Because of the rough estimates, conventional front-end processes are less than ideal, but can be useful, nevertheless, because they can identify some problems at an early stage.

During back-end processing, the HDL code and/or abstract objects representative of the HDL code are converted to a layout design of the integrated circuit. A typical layout design includes millions of gates and associated interconnections. The back-end processing arranges and re-arranges the gates in an attempt to obtain desired operational characteristics. This is often referred to as a “place and route” operation. Because of the sheer number of gates and interconnections, conventional back-end processing typically takes days to converge on a solution.

In many cases, the initial back-end operation is unable to obtain or converge on a design that meets the design criteria (i.e., desired operational characteristics). For example, the circuit may consume more power than called for, or may have internal gate or wire delays, which prevent proper operation. When this occurs, designers must revise the HDL code and repeat the front-end and back-end processes. EDA thus tends to be an iterative process, which may take days, weeks, or months to converge on a workable design.

Additional features related to front-end and back-end processing are provided below.

A. Front End: HDL and Synthesis

Integrated circuit designers write desired functionality into HDL code. During front-end design, the HDL code is converted, or synthesized, to a gate-level list (“gate-level netlist”) of transistor gates (“gates”) and interconnections. Synthesis typically includes optimization of the HDL code, such as by elimination of redundant terms. Synthesis can also revise the structure of the HDL code to improve performance.

Some conventional synthesis tools use models for certain types of logic, such as adders and multipliers. Conventional systems do not, however, utilize the models for placement operations and do not use actual physical information in the models (e.g., actual wire lengths and gate delay information). Thus, gate-level netlists generated by conventional synthesis systems typically require extensive additional optimization and iterations at the back end.

B. Back End: Place and Route

During back-end processing, the gate-level netlist is mapped onto an integrated circuit design. This includes iteratively rearranging the placement of the gates, and iteratively routing and re-routing interconnections so that the circuit meets given timing and power constraints. In addition to moving the gates around to minimize interconnection lengths (place and route), back end operations can include sizing and/or buffering. Sizing refers to replacement of one gate with another functionally equivalent gate to provide different drive. Because of the sheer number of gates involved in typical designs, optimization procedures that are executed in the back end are typically very time consuming and computationally demanding. The back-end process also involves the floorplanning of macros, black boxes, and user defined blocks, as well as the placement of I/O pads. This process is typically very difficult, requiring a lot of manual intervention, and is generally not in the skill set of a typical front-end designer.

II. Advanced Optional Processing Features, Abstract Representations of RTL, and Physical Synthesis

In order to reduce the work required during back end processing, groups of associated gates are optionally represented as objects. The objects represent functionality encoded by the HDL. Traditional back-end optimization operations, such as, and without limitation, logic optimization, floorplanning, placement, and/or routing operations can be performed on the objects at a high level by the front-end designer. These optimization operations done at a high level of abstraction reduce the work required in the back end and thus reduce the overall time required to convert HDL code to an integrated circuit design.

For example, Tera Systems, Inc., of San Jose, Calif., has developed logic objects (e.g., Tera Systems' TeraGates™), that provide realistic high-level representations of integrated circuit building blocks. Tera Systems, Inc. has also developed a number of processes for optimizing design layouts of objects, including logic objects (e.g., Tera Systems' TeraForm™). The realistic high level representations and associated processes allow for more accurate front end and back end optimizations at a high level of abstraction. As a result, the amount of work performed during back-end processing is significantly reduced.

Logic objects represent HDL code, or portions thereof. Each logic object typically represents multiple gates, sometimes thousands of gates. Logic objects can represent, for example, AND functions, OR functions, and more complex functions such as adders, multipliers, and multiplexers. The logic objects serve as high-level or abstract representations of the components of the integrated circuit design.

An important feature of the logic objects is that they include actual gate level physical information associated with the underlying gates. The physical information can include structural information for the underlying gates (e.g., net count, pin count, standard cell count, routing and blockage information), placement-based wire-load models for wires between gates, related placement information for gates included in the model, and actual timing and power information for the gates. The gate level physical information is obtained from integrated circuit fabrication facilities. Libraries of logic objects can be generated to incorporate various design features that are supported by a fabrication facility.

Inclusion of physical information in the logic objects, including use of placement-based wire-load models, and associated processes, are described in U.S. Pat. Nos. 6,145,117 and 6,360,356B1, and U.S. patent application Ser. No. 10/040,852, all titled, “Creating Optimized Physical Implementations from High-Level Descriptions of Electronic Design,” all of which are incorporated herein by reference in their entireties.

In operation, during front-end processing, HDL code, or portions thereof, is automatically converted to logic objects and other optional objects. The objects are then placed and routed during front-end processing.

Advanced front-end operations are performed on hundreds or thousands of logic objects and other types of optional objects, rather than the millions of gates that are operated on during back-end processing. Advanced front-end operations for processing logic objects include floorplanning, place and route operations, which take into account the actual physical information of the underlying circuitry that is represented by the logic objects.

Advanced front-end processing of objects essentially move back-end operations to the front-end. At the same time, the product automates these back-end operations to make the tool usable and accessible to conventional front-end designers, without requiring the years of experience that conventional back-end tools require for effective usage. As a result, design problems are more likely to be identified early on by the actual system designers instead of late in the design flow by the back-end engineering team. In addition, when the advanced front-end process converges on a place and route solution for the objects, the back-end process simply has to place and route gates within the area that was assigned to corresponding logic objects. In other words, there is generally no need for iterative back-end place and route operations to be performed on the overall design. Thus, back-end processing can typically be performed in a single pass.

When the advanced front-end synthesis process is performed with actual physical information, the synthesis operation is referred to herein as a “physical synthesis” operation. The front-end physical synthesis operation generates a netlist of objects rather than a gate level netlist. The netlist of objects includes gate level netlist information associated with each object that is needed during back-end processing. Since the objects have been placed during front-end processing, back-end processing can focus on detailed placement of the gates within each object. This substantially reduces the amount of work performed during back-end processing.

The objects optionally include information that maps the objects back to the corresponding RTL code. As a result, debugging of a design, at any level, can be mapped back to the corresponding RTL code.

RTL code can be converted into a variety of types of objects, examples of which are provided below. The invention is not, however, limited to the examples provided herein. Based on the description herein, one skilled in the relevant art(s) will understand that other types of objects can be utilized, and that objects may be of multiple types.

Objects, such as logic objects, allow the RTL code to be represented at a level of abstraction that is above a gate level netlist. The objects can be manipulated during front-end processing using fewer resources (e.g., computational resources and/or manpower resources) than what is required to manipulate corresponding gate level components.

For example, placement operations are optionally performed on the objects. Front-end placement operations provide placement information for the objects. During back-end processing, gates within the abstract objects are placed within the areas assigned to corresponding objects. Front-end operations performed on abstract objects are relatively fast because there are fewer objects to manipulate, compared to the number of gate level components in a netlist. The high-level operations thus reduce the overall time to reduce RTL code into an integrated circuit design.

A. Standard Cell Objects

Some portions of RTL code provide support functions for other features. Support functions can include, without limitation, glue logic, timing logic, control logic, memory logic, interconnection, etc. The term glue logic is used to broadly refer to features such as, and without limitation, buffers and/or interfacing functions. RTL code that provides such supporting functions is optionally represented as objects referred to herein as standard cell objects. A standard cell object may be an abstraction representing one or more transistors or gates, such as AND gates and OR gates. Standard cell objects can also include relatively simple sequential elements such as flip-flops and latches.

A standard cell object may include information such as, and without limitation, function(s) performed by the standard cell, area required to implement the standard cell, interconnections with other objects, and/or identification of the line(s) of RTL code that are associated with the standard cell.

B. Logic Objects

Some portions of HDL code are typically directed to more complex logical functions, such as arrayed or high fan-in AND operations and OR operations, multiplying operations, multiplexing operations, and more complex sequential operations (e.g., shift register, register file). Such HDL code is optionally represented by what is referred to herein as TeraGates™ or logic objects. A logic object is an abstraction that typically represents multiple gates and/or standard cells.

Logic objects include actual gate level physical information associated with the underlying gates, as described above. Logic objects also include information such as, and without limitation, function(s) performed by the logic object, area required to implement the logic object, interconnections with other objects, etc.

C. Memory and IP Blocks

A typical integrated circuit design includes one or more memory blocks and/or one or more proprietary blocks. Proprietary blocks are often referred to as intellectual property blocks or IP blocks. Memory blocks and proprietary blocks are optionally represented as objects during front-end processing.

D. Hierarchies

Designers often write RTL code with hierarchies, in which functions are grouped together according to some principle, such as according to an associated engineering group responsible for the code, and/or according to functions performed by the associated code. RTL functional hierarchies, and/or other hierarchies described below, are optionally maintained during synthesis.

In the actual layout of the integrated circuit, it may make more sense to re-group components from one hierarchy to another in order to optimize timing, routing, area, and/or power requirements. In some situations, therefore, functional RTL hierarchy designations are dissolved or ignored, in whole or in part, during front-end and/or back-end processing. The underlying logic encoded in the RTL is not ignored, only the grouping of logic functions.

E. Hard Objects and Soft Objects

Objects are optionally defined as hard objects or soft objects. Hard objects have fixed area and/or size constraints. Soft objects, on the other hand, have flexible area and/or size constraints.

Standard cell objects, memory, and IP blocks typically have fixed size and/or shape and are thus generally referred to as hard objects. Logic objects and hierarchies typically have variable size and/or area constraints and are thus considered soft objects.

III. Example Environment for RTL Processing with Logic Objects

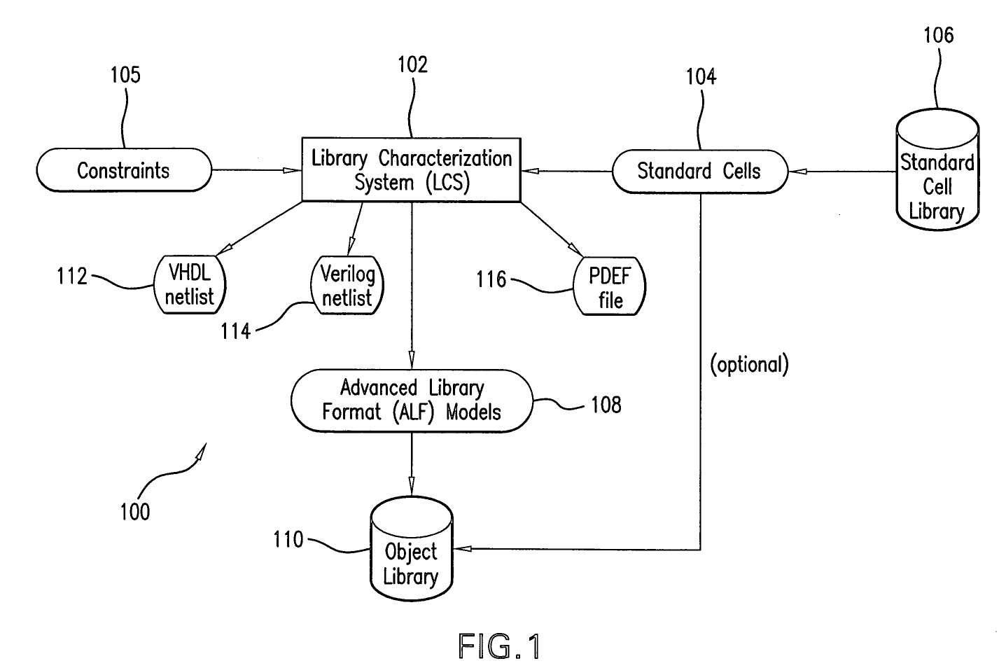

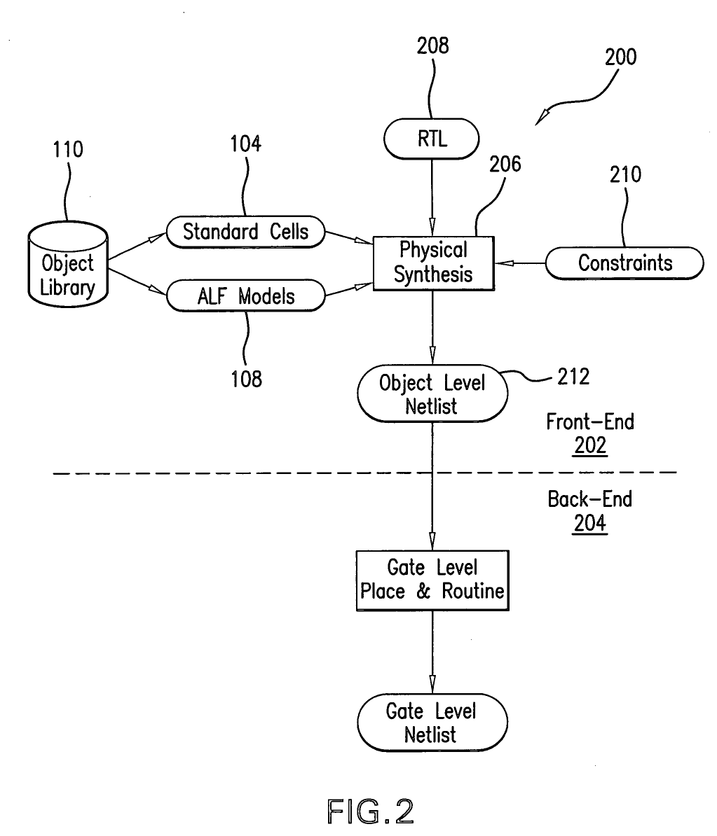

FIGS. 1 and 2 are example process flowcharts according to embodiments of the invention for processing RTL using logic objects. The invention is not, however, limited to the examples of FIGS. 1 and 2. Based on the description herein, one skilled in the relevant art(s) will understand that the invention can be implemented with other process flowcharts.

A. Generation of Libraries of Logic Objects

FIG. 1 is a process flowchart 100 for generating logic objects. A library characterization system (“LCS”) 102 receives standard cells 104 from a library of standard cells 106. The standard cells 104 typically include a plurality of standard logic cells such as, for example and without limitation, AND cells, OR cells, flip-flops, and the like. The standard cells 104 are optionally obtained from an integrated circuit fabrication facility, wherein the standard cells 104 incorporate process-dependent features of the fabrication facility, including timing, physical area, and power information.

The LCS 102 also receives constraints 105. The constraints 105 include gate level physical information for implementing the standard cells 104. The constraints 105 are typically associated with a fabrication facility and, more particularly, with an implementation technology of the fabrication facility. For example, and without limitation, the constraints 105 are optionally tailored for speed, power consumption, and/or process, voltage, and/or temperature operating ranges.

The LCS 102 generates, from standard cells 104 and in accordance with constraints 105, abstract models 108, such as, for example, advanced library format (“ALF”) models 109, VHDL netlist 112, Verilog netlist 114, and PDEF file 116. VHDL netlist 112 and Verilog netlist 114 may be used to provide a complete gate-level netlist to back-end tools. This precludes the need to run a separate gate-level synthesis in order to provide a full netlist to the back-end. PDEF file 116 includes relative placement information, which can be used to drive the detailed placement of back-end tools. This improves overall correlation with back-end tools. The abstract models 108 represent, for example and without limitation, one or more of the standard cells 104, and/or more complex logic, such as multipliers, multiplexers, Boolean logic or glue logic, and/or mega functions such as large adders, that are constructed from multiple standard cells 104.

The abstract models 108 include a variety of information derived from the physical gates needed to implement the logic object, such as pin information associated with the gates, interconnection information between the gate pins, detailed timing information, detailed area information, and/or other physical information, such as placement-based wire load models.

The abstract models 108 can also include information provided as part of the characterization process, such as bit widths, architecture, and constraints used to build the object.

The abstract models 108 are stored in an object library 110. The object library 110 optionally includes one or more standard cells 104, with or without physical information.

The library 110 is optionally generated, in whole or in part, in advance of need and/or on-the-fly. The libraries can also contain a description of the relative placement of gates within the object, which can be used to drive downstream back-end implementation tools. Multiple libraries 110 can be generated for different technologies using different sets of constraints 105.

B. Physical Synthesis Using Libraries of Logic Objects

FIG. 2 is a process flowchart 200 for synthesizing HDL code using logic objects. The process flowchart 200 includes a front-end processing section 202 and a back-end processing section 204.

A physical synthesis module 206 receives HDL code 208, abstract models 108 from object library 110, and constraints 210. The constraints 210 are for the design in process and are not the same as constraints 105 in FIG. 1. The physical synthesis module 206 optionally receives one or more standard cells 104.

The physical synthesis module 206 synthesizes the RTL code 208 using the ALF models 108 and the constraints 210. The physical synthesis module 206 optionally uses one or more standard cells 104. Physical synthesis includes traditional RTL synthesis as well as floorplanning, placement, and/or routing of the objects using physical information associated with the ALF models 108.

During synthesis, the physical synthesis module 206 generates instances of the ALF models 108 (i.e., logic objects) as needed to represent functionality encoded in the HDL 208. Each instance of a logic object retains most, if not all, of the information originally contained within the corresponding ALF model 108.

Each instance of a logic object is populated with an identification of the portion(s) of the RTL code 208 associated with the instance of the logic object. Each instance of the logic object is further populated with interconnection information to other objects. Thus each instance of a logic object includes gate level netlist information, timing and area information, and mapping information to corresponding RTL code. The RTL mapping information allows the objects to be mapped back to the RTL for troubleshooting and/or other purposes.

During physical synthesis, the physical synthesis module 206 optionally performs one or more conventional synthesis operations on the RTL code 208. Since each object represents multiple gates, manipulations of the objects takes considerably less computer processing time than would be required to perform similar manipulations of the individual gates at the back end.

During physical synthesis, the physical synthesis module 206 also optionally performs one or more unconventional synthesis operations on the RTL code 208, such as optimizing stacked logic. Stacked logic can be, for example, a bus of data lines that are ANDed together. Rather than generating a large number of small individual AND gates at the gate level, a single stacked, multiple input AND gate is used. The single stacked AND presents a single object to the tools, substantially improving the runtime and capacity. All of the process operating at this higher level of abstraction take advantage of this more advanced and efficient data model.

The physical synthesis module 206 outputs an object level netlist 212, which includes instances of logic objects. Each logic object includes associated gate level netlist information. The object level netlist 212 is passed to the back-end process 204, where place and route operations are performed on the gate level netlist information associated with the logic objects. This gate level netlist can be provided, for example, by LCS 102.

IV Cross-Probing

A. Representations Linked to Source RTL

During the front-end design process, an object is optionally populated with an identification of the line(s) of source RTL code associated with the object. Each object, such as a logic object, is further populated with interconnection information to other objects. Thus, each object includes, for example, gate-level netlist information, timing and area information, and mapping information to corresponding RTL code.

Cross-probing is the ability to maintain a reference between one or more representations and/or instances of objects in the circuit design and the source RTL code throughout the front-end design process. The references are optionally maintained throughout the back-end design process as well. Mapping references between multiple representations of an object allows the object to be identified simultaneously in different graphical representations of the source code. For example, cross-probing allows manual or automatic inspection into a particular instance of an object to see how it may affect or be affected by other portions of the IC design. This can be used to identify local and/or global design issues. Conventional EDA design tools lack this ability to maintain a reference to the original RTL code.

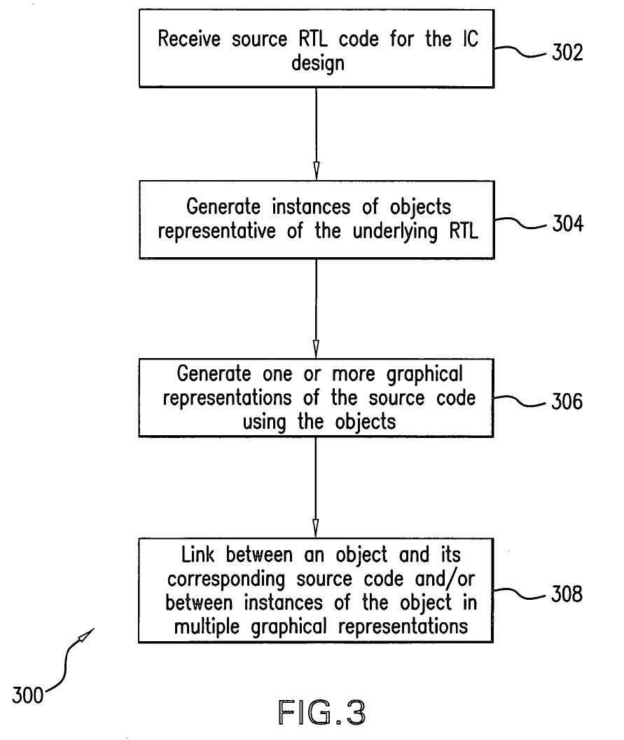

FIG. 3 is a flowchart of an example method 300 for cross-probing between multiple graphical representations of objects in an integrated circuit (“IC”) design. In step 302, source code for the IC design is received by, for example, an IC design program. The source code may be any type of logic source code or hardware description language (“HDL”) as described above.

In step 304, instances of objects representative of the source RTL code are generated by processing the source RTL. Each of the objects represents functionality performed by a plurality of IC gates. The objects can include, for example and without limitation, glue logic information, information about the interconnection between objects, and gate level physical information corresponding to the gates represented by the objects. The objects may be abstract objects such as standard cells and/or logic objects.

Particularly useful for cross-probing is the ability of the objects to include references to their corresponding sections of source RTL code. For example, specific lines of RTL defining an object may result in an instance of the object when processed. A link to the location of the specific RTL lines, called the “locator,” is maintained in each object instance. In another example, a reference between the object and the source code is stored in a directory. In yet another example, a particular naming convention for each object is maintained throughout the netlist to identify the section(s) of associated RTL code. Based on the teachings herein, one of skill in the relevant art(s) will understand that other methods can be implemented to include a reference to the source code in object instances without departing from the spirit and scope of the present invention.

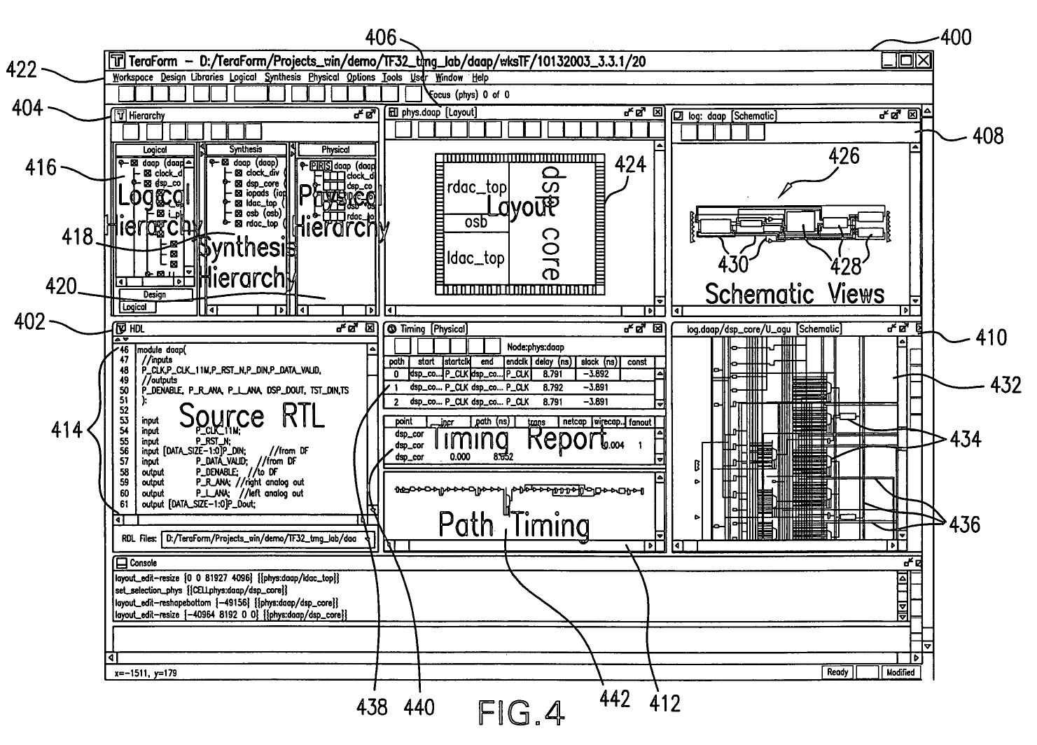

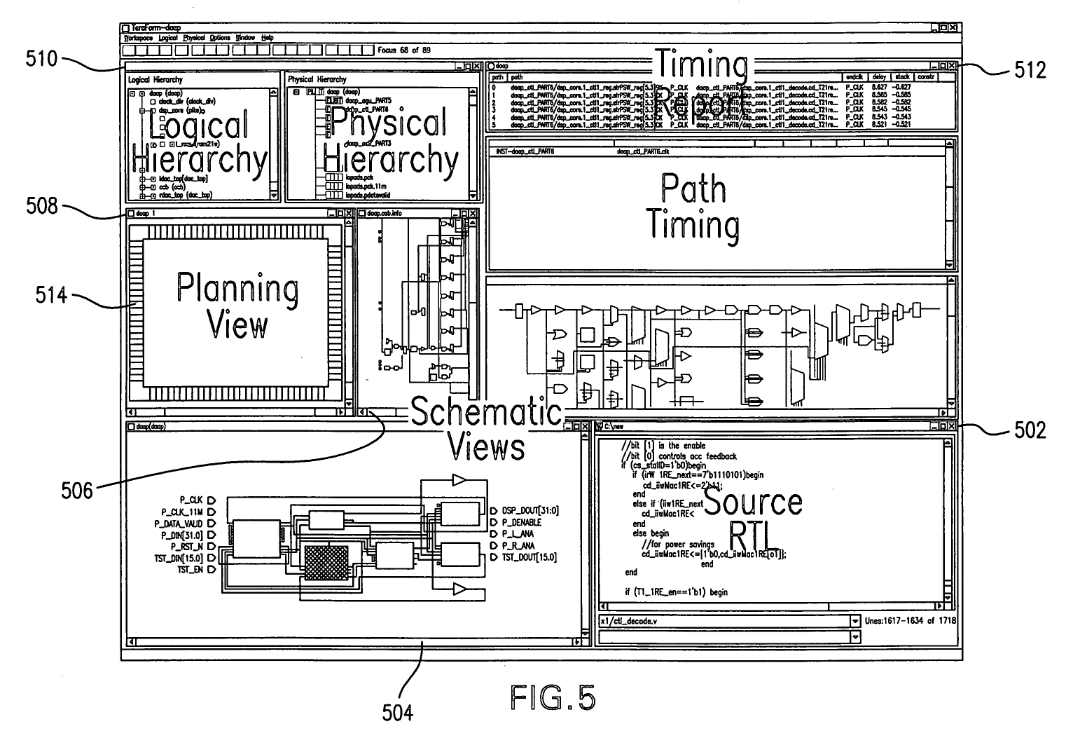

In step 306, once the object instances are generated, one or more graphical representations of the source code are generated using the object instances. The graphical representations maintain the references to the source RTL and may be displayed, for example, via a user interface for the IC design program. One type of representation that may be generated is a physical design, including layouts and schematics, in which the representations are arranged as the objects would be laid out on an IC chip. Another type of representation that may be generated is a design hierarchy in which the representations are arranged according to the relationships between the objects. Yet another type of representation that may be generated is a timing model, in which the representations are arranged according to the sequence by which a signal passes through them in the physical design. The textual representation present in the displayed source RTL may also be considered a representation. Each of these types of representation will be discussed below with reference to FIGS. 4 and 5.

In step 308, an object is linked to its corresponding source code and/or graphical representations of the object using the reference to the associated source RTL within the object as a linking reference. Because of this linkage, any action taken with respect to one representation of the object will be effected to other representations of the same object. For instance, if one representation is selected, causing the selection to be highlighted, all other representations of the same object will also be highlighted.

B. Graphical User Interface

FIGS. 4 and 5 are screenshots of example graphical user interfaces (“GUIs”) incorporating cross-probing method 300. Each interface in FIGS. 4 and 5 include multiple windows, which will be described below. The type and number of windows displayed can be chosen automatically or by the user, and can be tiled and/or stacked. One of skill in the relevant art(s) will recognize that any number of windows may be used for various types of data and displays desired.

FIG. 4 shows a screenshot of an example GUI 400 of the IC design tool. GUI 400 includes six primary windows: source RTL window 402, hierarchy window 404, layout window 406, high level schematic window 408, leaf level schematic window 410, and timing window 412. Each window may be opened automatically by the IC design tool. Alternatively or additionally, a user can manually open each window or a set of windows through options in a menu bar, such as menu bar 422.

Example source RTL 414 is displayed in source RTL window 402. Source RTL 414 may be produced at an outside source and read into the IC design tool. Alternatively or additionally, source RTL 414 may be entered or changed within source RTL window 402. Source RTL window 402 may be maintained by a code manager in the IC design tool.

Hierarchy window 404 of the present example includes logical hierarchy tree 416, synthesis hierarchy tree 418, and physical hierarchy tree 420. Although three hierarchy trees are shown in the present embodiment, any one or combination of hierarchy trees may be displayed. Hierarchy trees 416, 418, and 420 are generated based on source RTL 414. Each hierarchy tree includes object hierarchies and/or individual objects. Hierarchy window 404 and reference links from hierarchies 416, 418, and 420 to source RTL 414 may be maintained by a hierarchy manager in the IC design tool.

Logical hierarchy tree 416 is a listing of objects included in source RTL 414 that shows the hierarchical relationship between each object. For example, if source RTL 414 instantiates a primary block, and the primary block instantiates secondary blocks, the primary and secondary blocks will be displayed as having a parent-child relationship in logical hierarchy tree 416. Logical hierarchy tree 416 typically displays the hierarchical relationships as the RTL programmer designed the hierarchy in source RTL 414.

Synthesis hierarchy tree 418 is a version of logical hierarchy tree 416 optimized for analysis by a synthesis processor. Because synthesis processing takes a relatively significant amount of time, the logical hierarchy is broken into groups sized appropriately for processing by the synthesis processor. The result is the synthesis hierarchy tree. The synthesis hierarchy tree can be manipulated through flattening, in which certain hierarchies are dissolved so that their components are incorporated individually into a higher-level hierarchy. For example, if two objects in two different hierarchies would be processed more efficiently if they were in the same hierarchy, the synthesis hierarchy may flatten the original two hierarchies into their nearest common ancestor. As a result, the objects at issue would be members of the same hierarchy.

Flattening may be accomplished manually through user interaction by, for example, clicking and dragging one object or hierarchy on top of another object or hierarchy. In another example, flattening can be accomplished manually by selecting one or more specific components and choosing the appropriate action from a menu, such as can be found in menu bar 422. Alternatively or additionally, flattening may be performed automatically by the IC design tool.

Physical hierarchy tree 420 is a version of logical hierarchy tree 416 optimized for physical implementation (also referred to as floorplanning and/or placement). Physical implementation tools can process a larger amount of data than the synthesis tools, so physical hierarchy tree 420 flattens out many of the hierarchies from logical hierarchy tree 416 and synthesis hierarchy tree 418. The physical hierarchy tree is typically used as a guide for floorplanning and placement.

Although hierarchy boundaries may be created and/or dissolved in generating the different views, the ability to crossprobe is maintained regardless of how the hierarchy has been manipulated. This is particularly important when hierarchical objects are instantiated multiple times and in some view(s) the hierarchical boundaries are different. For example, this allows cross probing from an instance of an object in a view where hierarchical boundaries have been dissolved to the corresponding instance of the object in another view where hierarchical boundaries have not been dissolved.

In the example of FIG. 4, layout window 406 displays a high level block diagram 424 of the physical layout. Block diagram 424 includes several blocks representing high level hierarchies from physical hierarchy tree 420, and the predicted placement of each of those blocks on an IC chip. Although a high level diagram is shown in FIG. 4, block diagram 424 can be more detailed. For example, block diagram 424 can show the placement of individual objects within each hierarchy (see FIG. 5, described below). Additionally or alternatively, layout window 406 can display one or more block diagrams of layouts according to the synthesis and/or logical hierarchy trees. The diagrams are maintained by a diagram manager in the IC design tool. Layout window 406 and reference links between block diagram 424 and, for example, physical hierarchy tree 420, may be maintained by a layout manager within the diagram manager.

High level schematic window 408 displays an example high level schematic diagram 426 of the physical layout. Although, in the present example, schematic diagram 426 represents the physical layout, similar diagrams could be displayed of the logical and/or synthesis schematics, or of a group of objects selected by the user. Schematic diagram 426 displays hierarchical objects, such as high level objects 428, and the interconnections 430 between objects 428. A single high level object may include multiple lower-level objects.

Leaf level schematic window 410 displays an example leaf level schematic diagram 432 of the physical layout. A low level object is referred to as a “leaf”, since it is typically not further partitioned for processing until gate level placement at the back end. Leaf level schematic diagram 432 may display, for example, objects 434 such as abstract logic objects and/or standard cells, along with the interconnections 436 between objects 434. Each of the schematic diagrams and their reference links may be maintained by a schematic manager within the diagram manager.

In the present example, timing window 412 includes a critical path list 438, a timing report 440, and a timing schematic 442. One of ordinary skill in the art will recognize that other forms of timing information may be displayed instead of and/or in addition to those shown in timing window 412. Timing window 412 and its links to the layout block diagram 424, schematics 426 and 432, and/or source RTL 414 may be maintained by a timing manager within the IC design tool.

“Slack” is the difference between the time available for a signal to traverse a given path in the circuit and the time the signal actually takes to traverse the path. “Positive slack” means that the time available is greater than the time the path will take to run. “Negative slack” means that the path takes longer to run than the time available. Paths having negative slack are referred to as “critical paths.”

Example critical path list 438 displays the critical paths in order starting with the most critical path. Specifically, the path having the most negative slack is shown at the top of critical path list 438. When a critical path is selected in critical path list 438, timing report 440 displays information related to the selected path, such as, without limitation, the time it takes a signal to pass through path elements, the net capacitance of the path elements, the fan-in of a path element, and/or the fan-out of a path element. Both objects and connections between objects may be considered to be elements.

When a critical path is selected in critical path list 438, a schematic diagram of elements in the selected path is shown as timing schematic 442. Timing schematic 442 may include the net time of each element as a caption to the corresponding representation.

FIG. 5 shows a screenshot of another example GUI 500. GUI 500 includes source RTL window 502, high level schematic window 504, leaf level schematic window 506, layout window 508, hierarchy window 510, and timing window 512. As shown in FIG. 5, GUI 500 can display different numbers and types of windows, often tiled to a user's preference. For example, layout window 508 displays a low level block diagram 514, rather than the high level block diagram shown in layout window 406. Low level block diagram 514 includes several hierarchy blocks, as well as leaf level objects. One of skill in the art will recognize that any level of objects may be displayed in layout window 508.

C. Example Application

When using cross-probing, an action taken with respect to a first representation of an object will be reflected in other representations of the same object. This occurs because each representation of the object is linked or cross-referenced to other representations of the object, optionally through the source RTL.

For example, referring back to FIG. 4, physical layout 424 is generated based on physical hierarchy tree 420, with references or locators included therein. Physical hierarchy tree 420 is generated based on synthesis hierarchy tree 418, which is generated based on logical hierarchy tree 416, which is in turn generated based on source RTL 414. Schematic diagrams 426 and 432 are generated based on physical layout 424. Critical path list 438 and timing report 440 are also dependent on the layout of components as predicted by the physical layout block diagram 424. Timing schematic 442 is generated based on source RTL 414, since timing schematic 442 shows elements arranged in sequence of the signal path as encoded in source RTL 414. Thus, if an action occurs in one window, the referenced relationship between each object representation will update the other windows to take account of that action. The relationship of each of these displays and their ultimate dependency on the source RTL makes cross-probing possible.

Following the example of the GUI of FIG. 4, source RTL 414 may define a module “ADDER”. When logical hierarchy tree 416 is produced, it will include a representation of ADDER, since it is based on source RTL 414. Logical hierarchy tree 416 will also include a reference to source RTL 414 within the ADDER representation. Synthesis hierarchy tree 418 and physical hierarchy tree 420 will include the same reference since they, too, are ultimately generated based on source RTL 414.

Physical layout block diagram 424 is generated based on physical hierarchy 420. Therefore, the IC design tool will place a representation of ADDER in a particular location in block diagram 424 that includes references to the physical hierarchy tree 420 and/or source RTL 414. Since schematic diagrams 426 and 432 are generated based on the layout displayed in block diagram 424, each of schematic diagrams 426 and 432 will contain an ADDER representation including a similar reference. Timing report 440 is generated based on timing constraints, such as constraints 210 (FIG. 2), combined with location information about specific elements provided by the physical layout. Timing schematic 442 is generated based on sequence relationships between specific elements as defined by source RTL 414. Therefore, if ADDER is an element in a critical path, one or more additional representations of ADDER will be generated when ADDER's particular path is displayed. Like the previously-mentioned representations, the timing representations of ADDER will also contain a reference to source RTL 414 and/or physical hierarchy 420.

When action is taken with respect to any representation of ADDER, the link to source RTL 414 and/or links between the representations may be used to effect that action on every other representation of ADDER. For example, the representation of ADDER in timing schematic 442 may be highlighted. “Highlighted” in this context means any one of highlighted, selected, underlined, bolded, or otherwise emphasized. The IC design tool through, for example, a selection manager will recognize that the highlighted object is a representation of the module “ADDER” as encoded in source RTL 414. It will then search through each set of representations, such as timing report 440, synthesis hierarchy 418, and high-level schematic 426 for additional representations of ADDER. Upon finding each representation, the IC design tool will highlight the representation inside its corresponding window. If the representation was not initially visible in the window, the IC design tool will shift the display until the highlighted representation of ADDER can be viewed within the window. Additionally, the IC design tool will highlight the relevant lines of code and display them in source RTL window 402.

If the level of detail in a particular window is not the same as the level of detail in the window having a selection, the IC design tool will compensate. Continuing with the example of module “ADDER”, block diagram 424 of the physical layer is high-level, and may not specifically show the lower level representation of ADDER. In this case, the entire block or hierarchy in which ADDER can be found will be highlighted. For example, if ADDER is included in the block “DSP_CORE”, the entire DSP_CORE block will be highlighted.

Similarly, if the level of detail in a particular diagram is small, multiple components that make up the selected component may be affected. For example, leaf level schematic 432 shows finer detail than timing schematic 442. If ADDER is highlighted in timing schematic 442, several leaf level blocks in leaf level schematic 432 that make up the leaf level representation of ADDER may also be highlighted.

Such a technique can be useful in identifying reasons why a particular object or connection has negative slack. For instance, by highlighting an object in the critical path, a corresponding highlighted object in layout diagram 424 could identify congestion issues causing the object to take longer than it should to process a specific signal.

In addition to referencing individual objects, connections, or modules, an entire sequence of elements can be analyzed using a cross-probing method such as cross-probing method 300. For example, the entire critical path shown in timing schematic 442 may be highlighted. Because of cross-probing, all objects and/or connections included in the critical path will also appear highlighted in each window. Cross-probing in this instance can be used to identify the physical placement of each object in the critical path with, for example, layout diagram 424. When blocks containing elements of the critical path are highlighted, it may be evident that the elements are spread across the chip, or that the signal must be processed by several different blocks. Such a display may indicate that certain objects need to be moved, or that some hierarchies should be flattened to speed processing time between blocks.

Similarly, the objects in the critical path may be highlighted in the sequence in which they process a signal by, for example, a selection animator in the IC design tool. This type of animated highlighting can identify, for example, “snake paths”, where a signal passes back and forth between two different blocks several times. Much like the “scenic tour” described above, a snake path can be eliminated by flattening the two blocks together.

The reference to the source RTL is particularly useful when changes need to be made to the underlying code. Due to the high number of coded lines used for a single IC design, it would be very time-consuming and error-prone for a designer to search line-by-line for an object at issue. Since relevant lines of source RTL may be automatically highlighted in, for example, source RTL window 402, a designer can find the relevant RTL lines for the object immediately, determine if any errors were made in the initial draft of the source RTL, and make any changes needed in the source RTL without much delay or confusion due to location. Alternatively or additionally, the IC design tool may automatically update the source RTL if problems are found.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method of cross-probing between multiple graphical representations of objects in an integrated circuit design, comprising:
(a) receiving source code for the integrated circuit design;
(b) generating instances of objects representative of the source code, wherein the objects include references to the associated source code;
(c) generating one or more graphical representations of the source code using the instances of objects; and
(d) linking a graphical representation of a particular object to another graphical representation of the particular object, using the reference to the corresponding source code within the particular object as a linking reference.

2. The method of claim 1, wherein the objects further include interconnection information between the objects.

3. The method of claim 1, wherein each of the objects represents functionality performed by a plurality of integrated circuit gates.

4. The method of claim 3, wherein each of the objects further includes gate level physical information corresponding to the gates represented by the objects.

5. The method of claim 3, wherein the objects comprise gate level objects.

6. The method of claim 1, wherein said step (c) comprises one or more of:
arranging the graphical representations of objects in a design layout;
generating a timing model of the design layout;
generating a schematic view of the design layout;
generating a floorplan and wiring view of the design layout; and
generating a net view of the design layout.

7. The method of claim 6, wherein said step (d) comprises linking the timing model to the design layout.

8. The method of claim 6, wherein said step (d) comprises linking the schematic view to the design layout.

9. The method of claim 1, wherein said step (c) comprises arranging the graphical representations of objects in at least one hierarchy tree.

10. The method of claim 9, wherein said step (d) comprises linking the source code to a logical hierarchy.

11. The method of claim 9, wherein said step (d) comprises linking the source code to a synthesis hierarchy.

12. The method of claim 9, wherein said step (d) comprises linking the source code to a physical hierarchy.

13. The method of claim 1, wherein a hierarchy of the graphical representation is dissimilar from a hierarchy of the source code.

14. The method of claim 1, wherein a hierarchy of a first graphical representation is dissimilar from a hierarchy of a second graphical representation.

15. The method of claim 1, further comprising:
(e) displaying a plurality of the multiple graphical representations of objects in the integrated circuit design; and
(f) highlighting a corresponding sub-set of the displayed plurality of the multiple graphical representations.

16. A method of designing integrated circuits, comprising:
(a) displaying source code for an integrated circuit design, wherein the source code defines objects having multiple levels of abstraction;
(b) displaying at least one representation of an object; and
(c) linking the source code and the at least one representation such that any action in one effects a related action in the other.

17. The method of claim 16, wherein said step (b) comprises:
displaying at least one diagram relating to the displayed source code.

18. The method of claim 17, wherein said step (b) further comprises:
displaying at least one physical layout diagram relating to the displayed source code.

19. The method of claim 18, wherein said step (b) further comprises:
displaying at least one hierarchy-level physical layout diagram.

20. The method of claim 18, wherein said step (b) further comprises:
displaying at least one leaf-level physical layout diagram.

21. The method of claim 17, wherein said step (b) comprises:
displaying at least one schematic diagram relating to the displayed source code;
wherein the schematic diagram includes the at least one representation.

22. The method of claim 21, wherein said step (b) further comprises:
displaying at least one schematic diagram showing at least one representation of connections between objects.

23. The method of claim 16, wherein said step (b) comprises displaying at least one timing report of the integrated circuit design.

24. The method of claim 23, wherein said step (b) further comprises:
displaying a schematic of at least one critical path of the integrated circuit design;
wherein the critical path includes the at least one representation.

25. The method of claim 23, wherein said step (b) further comprises:
displaying a slack produced by each element in at least one critical path of the integrated circuit design.

26. The method of claim 23, wherein said step (b) further comprises:
displaying a list of at least one critical path in the integrated circuit design.

27. The method of claim 23, wherein said step (c) comprises linking displays produced by steps (a) and (b) such that selecting a critical path in the timing report will, in at least one other display, highlight representations of each element in the critical path in sequence according to positions of the elements in the critical path.

28. The method of claim 16, wherein said step (c) comprises linking displays produced by steps (a) and (b) such that selecting a representation of an element in one of the displays will highlight a representation of the same element in at least one other display.

29. The method of claim 16, wherein said step (b) comprises:
displaying at least one of a logical hierarchy tree, a synthesis hierarchy tree, and a physical hierarchy tree.

30. A front-end integrated circuit design tool, comprising:
(a) a code manager that displays source code for an integrated circuit design;
(b) a hierarchy manager that displays at least one hierarchy of objects; and
(c) a timing manager that displays a timing report of the integrated circuit design,
wherein the managers are linked such that any action in one of the managers effects a related action in each of the other managers.

31. The circuit design tool of claim 30, further comprising:
(d) a diagram manager that displays at least one diagram relating to the displayed source code.

32. The circuit design tool of claim 31, wherein said diagram manager comprises:
a layout manager that displays at least one layout diagram relating to the displayed source code.

33. The circuit design tool of claim 32, wherein the at least one layout diagram shows at least one hierarchy-level node.

34. The circuit design tool of claim 32, wherein the at least one layout diagram shows at least one leaf-level node.

35. The circuit design tool of claim 34, wherein at least one leaf-level node is a conglomerate of gate-level logic components.

36. The circuit design tool of claim 34, wherein at least one leaf-level node is a gate-level logic component.

37. The design tool of claim 31, wherein said diagram manager comprises:
a schematic manager that displays at least one schematic diagram relating to the displayed source code.

38. The design tool of claim 37, wherein the at least one schematic diagram shows at least one representation of connections between objects.

39. The design tool of claim 30, wherein the timing manager displays a schematic of at least one critical path.

40. The design tool of claim 30, wherein the timing manager displays a slack produced by each element in the at least one critical path.

41. The design tool of claim 30, wherein the timing manager displays a list of at least one critical path in the integrated circuit design.

42. The design tool of claim 30, further comprising:
a selection highlighter that highlights a representation of at least one specific element in each of the managers when a representation of the at least one specific element is selected in any one of the managers.

43. The design tool of claim 30, further comprising:
a selection animator that highlights at least one representation of each element in a critical path in an appropriate time sequence in each of the managers when a critical path displayed by the timing manager is highlighted.

44. The design tool of claim 30, wherein said hierarchy manager displays at least one of a logical hierarchy, a synthesis hierarchy, and a physical hierarchy.

45. The design tool of claim 30, wherein said source code is one of the following:
Verilog, VHDL, systemC and System Verilog.

46. A method of cross-probing between multiple graphical representations of objects in an integrated circuit design, comprising:
(a) receiving source code for the integrated circuit design;
(b) generating instances of objects representative of the source code, wherein the objects include a naming convention that identifies the associated source code;
(c) generating one or more graphical representations of the source code using the instances of objects; and
(d) linking a graphical representation of a particular object to another graphical representation of the particular object, using the reference to the corresponding source code within the particular object as a linking reference.
